(19) United States
(12) Patent Application Publication
(10) Pub. No.: US 2026/0228670 A1
(43) Pub. Date: Aug. 6, 2026

(54) ASSESSING DEVICE, ASSESSING METHOD, AND NON-TRANSITORY COMPUTER-READABLE MEDIUM

(71) Applicant: NEC Corporation, Tokyo (JP)

(72) Inventors: Noboru YOSHIDA, Tokyo (JP); Atsushi HONDA, Tokyo (JP); Yoshihiro KAJIKI, Tokyo (JP); Takayuki KASE, Tokyo (JP); Jianquan LIU, Tokyo (JP); Tingting DONG, Tokyo (JP)

(73) Assignee: NEC Corporation, Tokyo (JP)

(21) Appl. No.: 19/150,208

(22) PCT Filed: Jan. 16, 2024
(86) PCT No.: PCT/JP2024/000971

§ 371 Date: Jul. 23, 2025

(30) Foreign Application Priority Data
Jan. 27, 2023 (JP) 2023-010955

(51) Int. Cl. G06Q 10/0639; G06T 7/00; G06V 10/764

(52) U.S. Cl. CPC G06Q 10/06398; G06T 7/001; G06V 10/764

(57) ABSTRACT

The present invention provides an assessing device comprising: a reference image acquiring unit for acquiring a reference image; a reference image analyzing unit for identifying a worn item worn by a worker; a template information generating unit for generating worn item template information indicating the worn item that the worker should be wearing, on the basis of an analysis result of the reference image; a target image acquiring unit for acquiring a target image in which a worker to be assessed appears; a target image analyzing unit for identifying a worn item worn by the worker appearing in the target image; and an assessing unit for assessing whether the worker to be assessed is wearing the worn item that should be worn, on the basis of the worn item identified by analyzing the target image and the worn item indicated in the worn item template information.

### TECHNICAL FIELD

The present invention relates to an assessing device, an assessing method, and a program.

### BACKGROUND ART

Techniques related to the present invention are disclosed in PTL 1 to PTL 3.

The technique disclosed in PTL 1 detects a detection target such as clothes and equipment simultaneously with a face of a person. Then, the technique checks the belongings of the detection target and assesses whether the detection target is appropriately equipped from the positional relationship between the detected face and the detection target.

The technique disclosed in PTL 2 monitors, through image analysis, whether the appearance of the subject is in an appropriate state according to the working environment or the work content. The technique assesses whether the appearance of the subject is appropriate or not based on pre-prepared appropriateness state information. The appropriateness state information is information that defines an appropriate appearance that the worker is required to wear.

The technique disclosed in PTL 3 assesses, through image analysis, whether a target person is wearing equipment that should be worn. The technique identifies attributes of a target person through image analysis, and assesses whether the target person is wearing equipment corresponding to the identified attributes. The attributes are groups defined for each work content, affiliated departments, gender, and the like.

### CITATION LIST

### Patent Literature

PTL 1: JP 2012-237569 A

PTL 2: JP 2015-95209 A

PTL 3: JP 2014-154129

### SUMMARY OF INVENTION

### Technical Problem

At a work site such as a building site or a construction site, the worker may be required to wear a predetermined worn item for the purpose of securing safety of the worker or the like.

According to the techniques described in PTL 1 to PTL 3, it is possible to assess whether a worker is wearing a predetermined worn item through image analysis.

Incidentally, in the technique of assessing whether a worker is wearing a predetermined worn item through image analysis, it is necessary to input information indicating the “predetermined worn item that should be worn by the worker” to the system in advance. The system assesses whether the worker is wearing a predetermined worn item by comparing the worn item worn by the worker identified through the image analysis with a predetermined worn item that should be worn by the worker, which is identified by the information input in advance.

Then, a technique is desired that efficiently performs the work of inputting the information indicating the predetermined worn item that should be worn by the worker to the system. PTL 1 to PTL 3 do not disclose the problem and the solution thereof.

In view of the above-described problems, an object of the present invention is to provide an assessing device, an assessing method, and a program that solve the problem of efficiently performing a work of inputting information indicating a predetermined worn item that should be worn by a worker to a system, in a technique of assessing whether the worker is wearing the predetermined worn item through image analysis.

### Solution to Problem

According to an example aspect of the present invention, there is provided an assessing device including:
a reference image acquiring means for acquiring a reference image;
a reference image analyzing means for analyzing the reference image and identifying a worn item worn by a worker appearing in the reference image;
a template information generating means for generating worn item template information indicating the worn item that should be worn by the worker, based on an analysis result of the reference image, and storing the worn item template information in a storage means;
a target image acquiring means for acquiring a target image in which a worker to be assessed appears;
a target image analyzing means for analyzing the target image and identifying a worn item worn by the worker appearing in the target image; and
an assessing means for assessing whether the worker to be assessed is wearing the worn item that should be worn based on the worn item identified by analyzing the target image and the worn item indicated by the worn item template information.

According to another example aspect of the present invention, there is provided an assessing method including,
by one or more computers,
acquiring a reference image,
analyzing the reference image and identifying a worn item worn by a worker appearing in the reference image,
generating worn item template information indicating the worn item that should be worn by the worker, based on an analysis result of the reference image, and storing the worn item template information in a storage means,
acquiring a target image in which a worker to be assessed appears,
analyzing the target image and identifying a worn item worn by the worker appearing in the target image, and
assessing whether the worker to be assessed is wearing the worn item that should be worn based on the worn item identified by analyzing the target image and the worn item indicated by the worn item template information.

According to still another example aspect of the present invention, there is provided a recording medium storing a program that causes a computer to function as
a reference image acquiring means for acquiring a reference image,
a reference image analyzing means for analyzing the reference image and identifying a worn item worn by a worker appearing in the reference image,
a template information generating means for generating worn item template information indicating the worn item that should be worn by the worker, based on an analysis result of the reference image, and storing the worn item template information in a storage means,
a target image acquiring means for acquiring a target image in which a worker to be assessed appears,
a target image analyzing means for analyzing the target image and identifying a worn item worn by the worker appearing in the target image, and
an assessing means for assessing whether the worker to be assessed is wearing the worn item that should be worn based on the worn item identified by analyzing the target image and the worn item indicated by the worn item template information.

### Advantageous Effects of Invention

According to an example aspect of the present invention, an assessing device, an assessing method, and a program that solve the problem of efficiently performing a work of inputting information indicating a predetermined worn item that should be worn by a worker to a system are implemented, in a technique of assessing whether the worker is wearing the predetermined worn item through image analysis.

### BRIEF DESCRIPTION OF DRAWINGS

The above-described object and other objects, features, and advantages will be further clarified by the following suitable example embodiments and accompanying drawings.

FIG. 1 It is a diagram illustrating an example of a functional block diagram of an assessing device.

FIG. 2 It is a diagram illustrating an example of a hardware configuration of the assessing device.

FIG. 3 It is a diagram illustrating an example of a reference image.

FIG. 4 It is a flowchart illustrating an example of a flow of processing of the assessing device.

FIG. 5 It is a diagram illustrating another example of the reference image.

FIG. 6 It is a diagram illustrating an example of worn item template information.

FIG. 7 It is a diagram illustrating an output example of an assessment result.

FIG. 8 It is a diagram illustrating another output example of the assessment result.

FIG. 9 It is a diagram illustrating another output example of the assessment result.

FIG. 10 It is a flowchart illustrating another example of a flow of processing of the assessing device.

FIG. 11 It is a diagram illustrating an example of history information.

### EXAMPLE EMBODIMENT

Hereinafter, example embodiments of the present invention will be described with reference to the drawings. In all the drawings, the same components are denoted by the same reference numerals, and the description thereof will be omitted as appropriate.

### First Example Embodiment

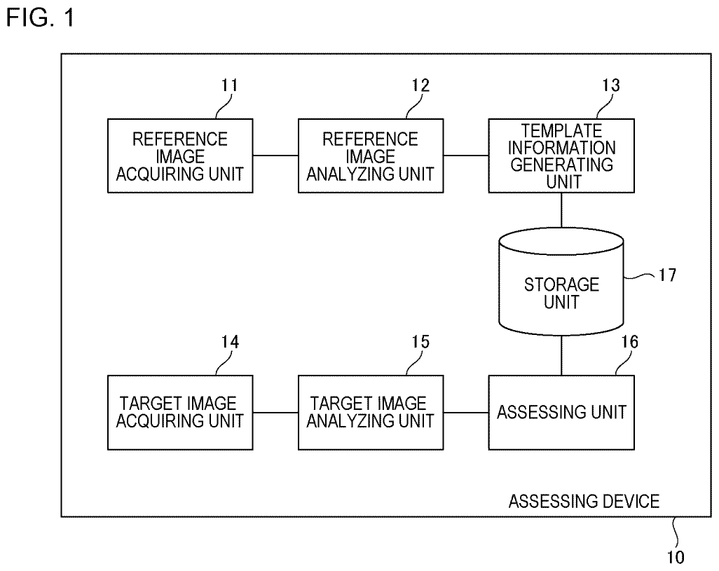

FIG. 1 is a functional block diagram illustrating an outline of an assessing device 10 according to a first example embodiment. The assessing device 10 includes a reference image acquiring unit 11, a reference image analyzing unit 12, a template information generating unit 13, a target image acquiring unit 14, a target image analyzing unit 15, an assessing unit 16, and a storage unit 17. The assessing device 10 may not include the storage unit 17. In this case, an external device configured to be able to communicate with the assessing device 10 includes the storage unit 17.

The reference image acquiring unit 11, the reference image analyzing unit 12, and the template information generating unit 13 make a preliminary preparation for assessment. Then, assessment is performed by the target image acquiring unit 14, the target image analyzing unit 15, and the assessing unit 16.

The assessment is an assessment as to whether a worker to be assessed is wearing a worn item that should be worn. The preliminary preparation is registration of information indicating a predetermined worn item that should be worn by the worker.

The reference image acquiring unit 11 acquires a reference image. The reference image analyzing unit 12 analyzes the reference image and identifies a worn item worn by a worker appearing in the reference image. Based on an analysis result of the reference image, the template information generating unit 13 generates worn item template information indicating a worn item that should be worn by the worker, and stores the worn item template information in the storage unit 17.

The target image acquiring unit 14 acquires a target image in which a worker to be assessed appears. The target image analyzing unit 15 analyzes the target image and identifies a worn item worn by the worker appearing in the target image. The assessing unit 16 assesses whether the worker to be assessed is wearing the worn item that should be worn based on the worn item identified by the analysis of the target image and the worn item indicated by the template information.

As described above, with the assessing device 10 of the first example embodiment that generates the worn item template information indicating the worn item that should be worn by the worker based on the analysis result of the reference image, it is possible to efficiently perform the work of inputting the information indicating the predetermined worn item that should be worn by the worker to the system.

### Second Example Embodiment

### [Overview]

An assessing device 10 of a second example embodiment is a more specific version of the assessing device 10 of the first example embodiment. More specifically, the assessing device 10 of the second example embodiment embodies processing of generating the worn item template information. The assessing device 10 of the second example embodiment analyzes a reference image obtained by imaging the worker wearing the worn item that should be worn, and generates worn item template information based on the worn item worn by the worker. Hereinafter, the configuration of the assessing device 10 will be described in detail.

### [Hardware Configuration]

An example of a hardware configuration of the assessing device 10 will be described. Each functional unit of the assessing device 10 is implemented by any combination of hardware and software. Those skilled in the art will understand that there are various modifications of the implementation method and device. The software includes a program stored in advance from a stage of shipping the device, a program downloaded from a recording medium such as a compact disc (CD), a server on the Internet, or the like.

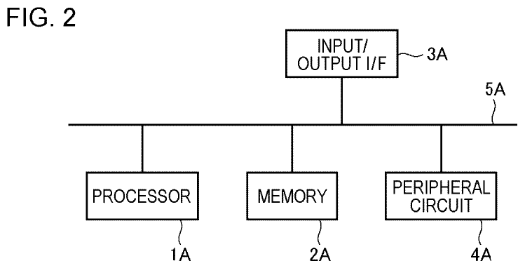

FIG. 2 is a block diagram illustrating the hardware configuration of the assessing device 10. As illustrated in FIG. 2, the assessing device 10 includes a processor 1A, a memory 2A, an input/output interface 3A, a peripheral circuit 4A, and a bus 5A. The peripheral circuit 4A includes various modules. The assessing device 10 may not include the peripheral circuit 4A. The assessing device 10 may include a plurality of physically and/or logically separated devices. In this case, each of the plurality of devices can have the above-described hardware configuration.

The bus 5A is a data transmission path through which the processor 1A, the memory 2A, the peripheral circuit 4A, and the input/output interface 3A mutually transmit and receive data. The processor 1A is an arithmetic processing unit such as a CPU or a graphics processing unit (GPU). The memory 2A is, for example, a memory such as a random access memory (RAM) or a read only memory (ROM). The input/output interface 3A includes an interface for acquiring information from an input device, an external device, an external server, an external sensor, a camera, and the like, and an interface for outputting information to an output device, an external device, an external server, and the like. In addition, the input/output interface 3A includes an interface for connecting to a communication network such as the Internet. The input device is, for example, a keyboard, a mouse, a microphone, a physical button, a touch panel, or the like. The output device is, for example, a display, a speaker, a printer, a mailer, or the like. The processor 1A can issue a command to each module and perform calculation based on the calculation results.

### [Functional Configuration]

Next, a functional configuration of the assessing device 10 of the present example embodiment will be described in detail. FIG. 1 illustrates an example of the functional block diagram of the assessing device 10. As illustrated, the assessing device 10 includes the reference image acquiring unit 11, the reference image analyzing unit 12, the template information generating unit 13, the target image acquiring unit 14, the target image analyzing unit 15, the assessing unit 16, and the storage unit 17. The assessing device 10 may not include the storage unit 17. In this case, an external device configured to be able to communicate with the assessing device 10 includes the storage unit 17.

The configurations of the target image acquiring unit 14, the target image analyzing unit 15, and the assessing unit 16 are similar to those of the first example embodiment. Hereinafter, configurations of the reference image acquiring unit 11, the reference image analyzing unit 12, the template information generating unit 13, and the storage unit 17 will be described.

The reference image acquiring unit 11 acquires a reference image. The reference image is an image in which a worker appears.

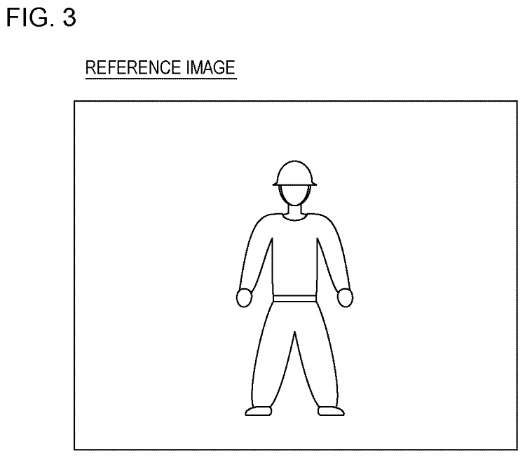

For example, as illustrated in FIG. 3, the reference image may be an image captured by having a worker stand in front of the camera. The reference image of the present example embodiment is an image generated by imaging the worker wearing the worn item that should be worn. A person may operate the camera to image the worker, and input the image to the assessing device 10 by any means. In addition, a camera installed at any place and communicably connected to the assessing device 10 may image the worker. Then, the camera may transmit the image to the assessing device 10 using a communication function. The reference image may be a moving image or a still image.

Returning to FIG. 1, the reference image analyzing unit 12 analyzes the reference image and identifies the worn item worn by the worker appearing in the reference image. That is, the reference image analyzing unit 12 identifies what kind of worn item the worker appearing in the reference image is wearing.

The worn items are work clothes, helmets, glasses, gloves, masks, work shoes, belongings, and the like. These worn items may be further subdivided. Then, the reference image analyzing unit 12 may identify which of the subdivided worn items is being worn.

In the image analysis, the processing of identifying the worn item worn by the worker appearing in the reference image is implemented using any technology. For example, a learning model that has learned the features of each worn item through machine learning may be used.

Based on an analysis result of the reference image, the template information generating unit 13 generates worn item template information indicating a worn item that should be worn by the worker, and stores the worn item template information in the storage unit 17.

In the present example embodiment, the reference image acquiring unit 11 acquires the reference image obtained by imaging a “worker wearing the worn item that should be worn”.

Then, the reference image analyzing unit 12 analyzes the reference image and identifies the worn item worn by the “worker wearing the worn item that should be worn”.

The template information generating unit 13 generates worn item template information indicating the “worn item identified by the reference image analyzing unit 12” as the “worn item that should be worn by the worker”.

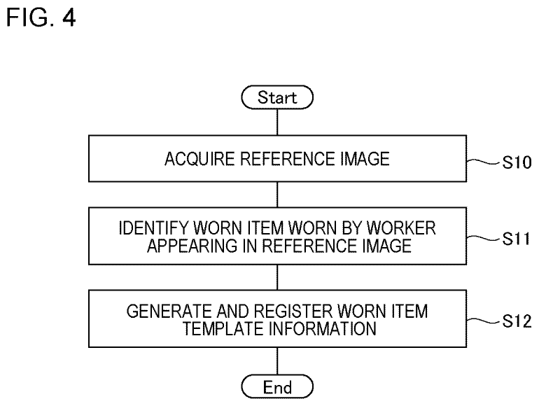

Next, an example of a flow of processing of the assessing device 10 will be described with reference to a flowchart of FIG. 4.

First, the assessing device 10 acquires a reference image obtained by imaging the “worker wearing the worn item that should be worn” (S10). Next, the assessing device 10 analyzes the reference image and identifies the worn item worn by the “worker wearing the worn item that should be worn” appearing in the reference image (S11). The assessing device 10 generates the worn item template information indicating the “worn item identified in S11” as the “worn item that should be worn by the worker”, and registers (stores in the storage unit 17) the worn item template information (S12).

### [Operations and Effects]

With the assessing device 10 of the second example embodiment, operations and effects similar to those of the assessing device 10 of the first example embodiment are implemented.

In addition, with the assessing device 10 of the second example embodiment that analyzes the reference image obtained by imaging the “worker wearing the worn item that should be worn” and generates the worn item template information, the worn item template information appropriately indicating the worn item that should be worn can be generated.

### Third Example Embodiment

### [Overview]

An assessing device 10 of a third example embodiment is a more specific version of the assessing device 10 of the first example embodiment. More specifically, the assessing device 10 of the third example embodiment embodies processing of generating the worn item template information. The assessing device 10 of the third example embodiment detects a predetermined worker who is considered to be wearing a worn item that should be worn from an image (reference image) obtained by imaging a work site, and generates worn item template information based on the worn item worn by the worker. Hereinafter, the configuration of the assessing device 10 will be described in detail.

### [Hardware Configuration]

Since the hardware configuration is the same as that of the assessing device 10 of the second example embodiment, the description thereof will be omitted here.

### [Functional Configuration]

Next, a functional configuration of the assessing device 10 of the present example embodiment will be described in detail. FIG. 1 illustrates an example of the functional block diagram of the assessing device 10. As illustrated, the assessing device 10 includes the reference image acquiring unit 11, the reference image analyzing unit 12, the template information generating unit 13, the target image acquiring unit 14, the target image analyzing unit 15, the assessing unit 16, and the storage unit 17. The assessing device 10 may not include the storage unit 17. In this case, an external device configured to be able to communicate with the assessing device 10 includes the storage unit 17.

The configurations of the target image acquiring unit 14, the target image analyzing unit 15, and the assessing unit 16 are similar to those of the first example embodiment. Hereinafter, configurations of the reference image acquiring unit 11, the reference image analyzing unit 12, the template information generating unit 13, and the storage unit 17 will be described.

The reference image acquiring unit 11 acquires a reference image. The reference image is an image in which a worker appears. The reference image may be a moving image or a still image.

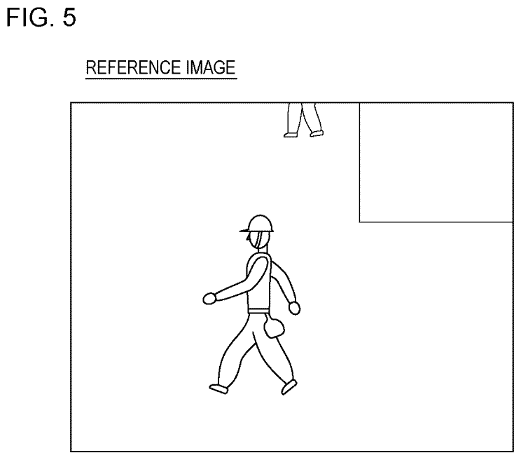

The reference image of the present example embodiment is, for example, an image obtained by imaging a worker who is working at a work site as illustrated in FIG. 5. A person may operate the camera to image the work site, and input the image to the assessing device 10 by any means. In addition, a camera installed at any place of the work site and communicably connected to the assessing device 10 may image the work site. Then, the camera may transmit the image to the assessing device 10 using a communication function. In addition, a device including a moving means and a camera and further communicably connected to the assessing device 10 may capture an image of the work site while moving in the work site. Then, the device may transmit the image to the assessing device 10 using a communication function. The moving means may be means for moving on land or means for moving in the air.

The reference image analyzing unit 12 detects a predetermined worker from an image (reference image) captured at the work site based on feature quantities of the appearance of the predetermined worker registered in advance. Then, the reference image analyzing unit 12 analyzes the reference image and identifies the worn item worn by the detected predetermined worker.

The predetermined worker is a worker who is considered to be wearing a worn item that should be worn. For example, the predetermined worker is a skilled person, a leader, a model worker, or the like, but is not limited thereto.

The feature quantities of the appearance of the predetermined worker are information for detecting the worker through image analysis, and are, for example, face information, a physique, a height, a gait, or the like. The processing of detecting a predetermined worker from the image based on these feature quantities is implemented by any means.

The processing of identifying the worn item worn by the detected predetermined worker is similar to the “processing of identifying the worn item worn by the worker appearing in the reference image” described in the second example embodiment.

Based on an analysis result of the reference image, the template information generating unit 13 generates worn item template information indicating a worn item that should be worn by the worker, and stores the worn item template information in the storage unit 17.

In the present example embodiment, the reference image acquiring unit 11 acquires an image captured at the work site as a reference image. Then, the reference image analyzing unit 12 detects the “predetermined worker who is considered to be wearing a worn item that should be worn” from the image captured at the work site, and identifies the worn item worn by the worker. In this manner, the reference image analyzing unit 12 identifies a worn item worn by the predetermined worker appearing in the image captured at the work site.

The template information generating unit 13 generates worn item template information indicating a “worn item identified by the reference image analyzing unit 12 (the worn item worn by the predetermined worker)” as the “worn item that should be worn by the worker” based on the analysis result of the image captured at the work site.

Note that the assessing device 10 of the present example embodiment may include the configuration of the assessing device 10 of the second example embodiment. That is, the assessing device 10 of the present example embodiment may include both the means for generating the worn item template information described in the second example embodiment and the means for generating the worn item template information described in the present example embodiment.

Next, an example of a flow of processing of the assessing device 10 will be described with reference to a flowchart of FIG. 4.

First, the assessing device 10 acquires an image captured at the work site as a reference image (S10). Next, the assessing device 10 detects a predetermined worker from the image (reference image) captured at the work site based on feature quantities of the appearance of the predetermined worker registered in advance. Then, the assessing device 10 analyzes the reference image and identifies the worn item worn by the detected predetermined worker (S11). The assessing device 10 generates the worn item template information indicating the “worn item identified in S11” as the “worn item that should be worn by the worker”, and registers (stores in the storage unit 17) the worn item template information (S12).

### [Operations and Effects]

With the assessing device 10 of the third example embodiment, operations and effects similar to those of the assessing device 10 of the first example embodiment are implemented.

In addition, the assessing device 10 of the third example embodiment detects the “predetermined worker who is considered to be wearing the worn item that should be worn” from the image captured on site, and generates the worn item template information based on the identification result of the worn item worn by the worker. With the assessing device 10 of the third example embodiment, it is possible to generate the worn item template information appropriately indicating the worn item that should be worn. In addition, in the case of the assessing device 10 according to the third example embodiment, it is not necessary to deliberately stop or call over a predetermined worker for imaging the reference image. Therefore, it is possible to reduce a burden on the predetermined worker.

In addition, in a case where the assessing device 10 of the third example embodiment has the same configuration as the assessing device 10 of the second example embodiment, the same operations and effects can be implemented.

### Fourth Example Embodiment

### [Overview]

An assessing device 10 of a fourth example embodiment is a more specific version of the assessing device 10 of the first example embodiment. More specifically, the assessing device 10 of the fourth example embodiment embodies processing of generating the worn item template information. The assessing device 10 of the fourth example embodiment analyzes an image (reference image) obtained by imaging the work site, identifies the worn items of the plurality of workers, and generates the worn item template information based on the identification result. Hereinafter, the configuration of the assessing device 10 will be described in detail.

### [Hardware Configuration]

Since the hardware configuration is the same as that of the assessing device 10 of the second example embodiment, the description thereof will be omitted here.

### [Functional Configuration]

Next, a functional configuration of the assessing device 10 of the present example embodiment will be described in detail. FIG. 1 illustrates an example of the functional block diagram of the assessing device 10. As illustrated, the assessing device 10 includes the reference image acquiring unit 11, the reference image analyzing unit 12, the template information generating unit 13, the target image acquiring unit 14, the target image analyzing unit 15, the assessing unit 16, and the storage unit 17. The assessing device 10 may not include the storage unit 17. In this case, an external device configured to be able to communicate with the assessing device 10 includes the storage unit 17.

The configurations of the target image acquiring unit 14, the target image analyzing unit 15, and the assessing unit 16 are similar to those of the first example embodiment. Hereinafter, configurations of the reference image acquiring unit 11, the reference image analyzing unit 12, the template information generating unit 13, and the storage unit 17 will be described.

The reference image acquiring unit 11 acquires a reference image. The reference image is an image in which a worker appears. For example, as illustrated in FIG. 5, the reference image acquiring unit 11 acquires an image obtained by imaging a worker who is working at a work site as the reference image. Since the means for acquiring such a reference image has been described in the third example embodiment, the description thereof will be omitted here.

The reference image analyzing unit 12 identifies a worn item worn by each of a plurality of workers appearing in an image (reference image) captured at the work site. The processing of identifying the worn item worn by the worker is similar to the “processing of identifying the worn item worn by the worker appearing in the reference image” described in the second example embodiment.

The template information generating unit 13 generates the worn item template information based on the result identified by the reference image analyzing unit 12, and stores the worn item template information in the storage unit 17.

The template information generating unit 13 can generate the worn item template information indicating the “worn item possessed by a predetermined number or more of workers among the plurality of workers appearing in the reference image” as the worn item that should be worn by the worker.

Alternatively, the template information generating unit 13 can generate the worn item template information indicating the “worn item possessed by a predetermined proportion or more of workers among the plurality of workers appearing in the reference image” as the worn item that should be worn by the worker.

At a work site, it is considered that a majority of workers wear a worn item that should be worn. Therefore, appropriate worn item template information is generated by the processing by template information generating unit 13.

Note that the assessing device 10 of the present example embodiment may include at least one configuration of the assessing devices 10 of the second and third example embodiments. That is, the assessing device 10 of the present example embodiment may include at least one of the means for generating the worn item template information described in the second example embodiment and the means for generating the worn item template information described in the third example embodiment, and the means for generating the worn item template information described in the present example embodiment.

Next, an example of a flow of processing of the assessing device 10 will be described with reference to a flowchart of FIG. 4.

First, the assessing device 10 acquires an image captured at the work site as a reference image (S10). Next, the assessing device 10 identifies the worn item worn by each of the plurality of workers appearing in the image (reference image) captured at the work site (S11). Then, assessing device 10 generates and registers (stores in the storage unit 17) the worn item template information based on the identification result of S11 (S12). Specifically, the assessing device 10 generates, as the worn item that should be worn by the worker, the worn item template information indicating the worn item possessed by a predetermined number or more of workers, and the worn item possessed by a predetermined proportion or more of workers among the plurality of workers appearing in the reference image.

### [Operations and Effects]

With the assessing device 10 of the fourth example embodiment, operations and effects similar to those of the assessing device 10 of the first example embodiment are implemented.

In addition, the assessing device 10 of the fourth example embodiment identifies the worn item worn by each of the plurality of workers based on the image captured on site, and generates the worn item template information based on the measurement result. At a work site, it is considered that a majority of workers wear a worn item that should be worn. Therefore, with the assessing device 10 of the fourth example embodiment, it is possible to generate the worn item template information appropriately indicating the worn item that should be worn. In addition, in the case of the assessing device 10 according to the fourth example embodiment, it is not necessary to deliberately stop or call over a predetermined worker for imaging the reference image. Therefore, it is possible to reduce a burden on the predetermined worker.

In a case where the assessing device 10 of the fourth example embodiment has the same configuration as at least one of the assessing device 10 of the second example embodiment and the assessing device 10 of the third example embodiment, the same operations and effects can be implemented.

### Fifth Example Embodiment

### [Overview]

The worn item that should be worn by the worker may be different for each work type. The assessing device 10 of the fifth example embodiment may include the means for generating the worn item template information for each work type in the means for generating the worn item template information described in the second example embodiment. Details will be described below.

### [Hardware Configuration]

Since the hardware configuration is the same as that of the assessing device 10 of the second example embodiment, the description thereof will be omitted here.

### [Functional Configuration]

Next, a functional configuration of the assessing device 10 of the present example embodiment will be described in detail. FIG. 1 illustrates an example of the functional block diagram of the assessing device 10. As illustrated, the assessing device 10 includes the reference image acquiring unit 11, the reference image analyzing unit 12, the template information generating unit 13, the target image acquiring unit 14, the target image analyzing unit 15, the assessing unit 16, and the storage unit 17. The assessing device 10 may not include the storage unit 17. In this case, an external device configured to be able to communicate with the assessing device 10 includes the storage unit 17.

The configurations of the target image acquiring unit 14, the target image analyzing unit 15, and the assessing unit 16 are similar to those of the first example embodiment. Hereinafter, configurations of the reference image acquiring unit 11, the reference image analyzing unit 12, the template information generating unit 13, and the storage unit 17 will be described.

The reference image acquiring unit 11 acquires a reference image for each work type. The reference image associated with each work type is an image obtained by imaging the worker wearing the worn item that should be worn in the work of each work type.

For example, a person may input the reference image to the assessing device 10 in association with the work type. In addition, a person may associate the work type with the reference image acquired by the reference image acquiring unit 11. The “work type” is a type of work, and examples thereof include high-place work, carry-in work, machine operation work, and the like. There are various ways of classifying the work type, and there is no particular limitation. Other configurations of the reference image acquiring unit 11 are the same as those described in the second example embodiment, and thus the description thereof will be omitted here.

Here, an example of a worn item that should be worn in the work of each work type will be described. In the high-place work, a safety belt is exemplified. In the welding work, a welding mask is exemplified. In the work of handling a predetermined chemical (special chemical), lab coats, protective masks, and the like are exemplified. In the work of touching a predetermined object (object at high temperature, knives, and the like), gloves are exemplified. In the work related to the electric system, a rubber glove is exemplified. In the work performed in the clean room, a dustproof clothing is exemplified. In the work for handling heavy objects, safety shoes and helmets are exemplified.

The configurations of the reference image analyzing unit 12 are the same as those described in the second example embodiment, and thus the description thereof will be omitted here.

The template information generating unit 13 generates worn item template information indicating a worn item that should be worn by the worker for each work type, and stores the worn item template information in the storage unit 17. In the worn item template information associated with each work type, the worn item identified by analyzing the reference image associated with each work type is indicated as the worn item that should be worn.

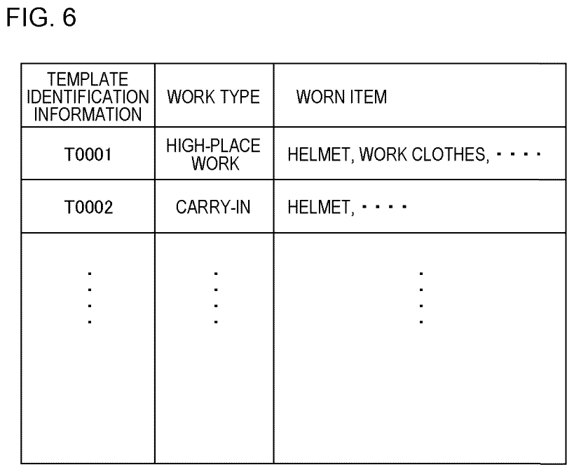

FIG. 6 schematically illustrates an example of worn item template information. The worn item template information illustrated in FIG. 6 includes items of template identification information, a work type, and a worn item.

In the item of the template identification information, information for identifying the plurality of pieces of worn item template information from each other is input.

In the item of work type, the content of the work type is input.

In the item of worn item, a worn item that should be worn by a worker who performs a work of each work type is input.

Other configurations of the template information generating unit 13 are the same as those described in the second example embodiment, and thus the description thereof will be omitted here.

Next, an example of a flow of processing of the assessing device 10 will be described with reference to a flowchart of FIG. 4.

First, the assessing device 10 acquires a reference image obtained by imaging the worker wearing the worn item that should be worn for each work type (S10). Next, the assessing device 10 analyzes the reference image for each work type and identifies the worn item worn by “the worker wearing the worn item that should be worn” appearing in each reference image (S11). The assessing device 10 generates the worn item template information indicating the “worn item identified in S11” as the “worn item that should be worn by the worker” for each work type, and registers (stores in the storage unit 17) the worn item template information (S12).

### [Operations and Effects]

With the assessing device 10 of the fifth example embodiment, operations and effects similar to those of the assessing device 10 of the first and second example embodiments are implemented.

The worn item that should be worn by the worker may be different for each work type. With the assessing device 10 of the fifth example embodiment, it is possible to generate the worn item template information appropriately indicating the worn item that should be worn for each work type.

### Sixth Example Embodiment

### [Overview]

The worn item that should be worn by the worker may be different for each work type. An assessing device 10 of a sixth example embodiment may include the means for generating the worn item template information for each work type in the means for generating the worn item template information described in the third example embodiment. Details will be described below.

### [Hardware Configuration]

Since the hardware configuration is the same as that of the assessing device 10 of the second example embodiment, the description thereof will be omitted here.

### [Functional Configuration]

Next, a functional configuration of the assessing device 10 of the present example embodiment will be described in detail. FIG. 1 illustrates an example of the functional block diagram of the assessing device 10. As illustrated, the assessing device 10 includes the reference image acquiring unit 11, the reference image analyzing unit 12, the template information generating unit 13, the target image acquiring unit 14, the target image analyzing unit 15, the assessing unit 16, and the storage unit 17. The assessing device 10 may not include the storage unit 17. In this case, an external device configured to be able to communicate with the assessing device 10 includes the storage unit 17.

The configurations of the target image acquiring unit 14, the target image analyzing unit 15, and the assessing unit 16 are similar to those of the first example embodiment. Hereinafter, configurations of the reference image acquiring unit 11, the reference image analyzing unit 12, the template information generating unit 13, and the storage unit 17 will be described.

The configurations of the reference image acquiring unit 11 are the same as those described in the third example embodiment, and thus the description thereof will be omitted here.

As described in the third example embodiment, the reference image analyzing unit 12 detects a predetermined worker from an image (reference image) captured at the work site based on feature quantities of the appearance of the predetermined worker registered in advance. Then, the reference image analyzing unit 12 identifies the worn item worn by the worker using the means described in the third example embodiment.

In addition, the reference image analyzing unit 12 analyzes the reference image and identifies the work type of the work performed by the detected predetermined worker. The work type can be identified based on the posture of the worker, tools and machines used by the worker, objects to be worked, the number of workers, and the like. In the image analysis, the processing of identifying the work type of the worker appearing in the reference image is implemented using any technology. For example, a learning model that has learned the above-described features at the time of performing various works may be used.

The template information generating unit 13 generates worn item template information indicating a worn item that should be worn by the worker for each work type, and stores the worn item template information in the storage unit 17.

The template information generating unit 13 generates worn item template information indicating a “worn item worn by a predetermined worker identified by the reference image analyzing unit 12” as a “worn item that should be worn by a worker who performs a work of a work type identified by the reference image analyzing unit 12”. An example of the worn item template information is illustrated in FIG. 6. The worn item template information of FIG. 6 has been described in the fifth example embodiment, and thus the description thereof will be omitted here.

Other configurations of the template information generating unit 13 are the same as those described in the third example embodiment, and thus the description thereof will be omitted here.

Next, an example of a flow of processing of the assessing device 10 will be described with reference to a flowchart of FIG. 4.

First, the assessing device 10 acquires an image captured at the work site as a reference image (S10). Next, the assessing device 10 detects a predetermined worker from the image (reference image) captured at the work site based on feature quantities of the appearance of the predetermined worker registered in advance. Then, the assessing device 10 analyzes the reference image and identifies the worn item worn by the detected predetermined worker (S11). In addition, in S11, the assessing device 10 analyzes the reference image and identifies the work type of the work performed by the detected predetermined worker.

The assessing device 10 generates the worn item template information indicating the “worn item identified in S11” as the “worn item that should be worn by the worker who performs the work of the work type identified in S11”, and registers (stores in the storage unit 17) the worn item template information (S12).

### [Operations and Effects]

With the assessing device 10 of the sixth example embodiment, operations and effects similar to those of the assessing device 10 of the first and third example embodiments are implemented.

The worn item that should be worn by the worker may be different for each work type. With the assessing device 10 of the sixth example embodiment, it is possible to generate the worn item template information appropriately indicating the worn item that should be worn for each work type.

### Seventh Example Embodiment

### [Overview]

The worn item that should be worn by the worker may be different for each work type. An assessing device 10 of a seventh example embodiment may include the means for generating the worn item template information for each work type in the means for generating the worn item template information described in the fourth example embodiment. Details will be described below.

### [Hardware Configuration]

Since the hardware configuration is the same as that of the assessing device 10 of the second example embodiment, the description thereof will be omitted here.

### [Functional Configuration]

Next, a functional configuration of the assessing device 10 of the present example embodiment will be described in detail. FIG. 1 illustrates an example of the functional block diagram of the assessing device 10. As illustrated, the assessing device 10 includes the reference image acquiring unit 11, the reference image analyzing unit 12, the template information generating unit 13, the target image acquiring unit 14, the target image analyzing unit 15, the assessing unit 16, and the storage unit 17. The assessing device 10 may not include the storage unit 17. In this case, an external device configured to be able to communicate with the assessing device 10 includes the storage unit 17.

The configurations of the target image acquiring unit 14, the target image analyzing unit 15, and the assessing unit 16 are similar to those of the first example embodiment. Hereinafter, configurations of the reference image acquiring unit 11, the reference image analyzing unit 12, the template information generating unit 13, and the storage unit 17 will be described.

The configurations of the reference image acquiring unit 11 are the same as those described in the fourth example embodiment, and thus the description thereof will be omitted here.

The reference image analyzing unit 12 identifies a worn item worn by each of a plurality of workers appearing in an image (reference image) captured at the work site. The processing is as described in the fourth example embodiment. The reference image analyzing unit 12 identifies a work type of a work performed by each of the plurality of workers appearing in the image (reference image) captured at the work site. The processing of identifying the work type through the image analysis is as described in the sixth example embodiment.

The template information generating unit 13 generates worn item template information indicating a worn item that should be worn by the worker for each work type, and stores the worn item template information in the storage unit 17.

The template information generating unit 13 identifies, for each work type, the worn item possessed by a predetermined number or more of workers or worn items possessed by a predetermined proportion or more of workers among the “workers who are performing work of each work type appearing in the reference image”. Then, the template information generating unit 13 generates the worn item template information indicating the worn item identified for each work type as the worn item that should be worn by the worker who is performing the work of each work type.

Next, an example of a flow of processing of the assessing device 10 will be described with reference to a flowchart of FIG. 4.

First, the assessing device 10 acquires an image captured at the work site as a reference image (S10). Next, the assessing device 10 identifies the worn item worn by each of the plurality of workers appearing in the image (reference image) captured at the work site (S11). In S11, the assessing device 10 identifies a work type of a work performed by each of the plurality of workers appearing in the image (reference image) captured at the work site.

Then, assessing device 10 generates and registers (stores in the storage unit 17) the worn item template information based on the identification result of S11 (S12). Specifically, the assessing device 10 generates, as the worn item that should be worn by the worker who is performing each work type, the worn item template information indicating the worn items possessed by a predetermined number or more of workers or the worn items possessed by a predetermined proportion or more of workers among the “workers who are performing the work of each work type appearing in the reference image”.

### [Operations and Effects]

With the assessing device 10 of the seventh example embodiment, operations and effects similar to those of the assessing device 10 of the first and fourth example embodiments are implemented.

The worn item that should be worn by the worker may be different for each work type. With the assessing device 10 of the seventh example embodiment, it is possible to generate the worn item template information appropriately indicating the worn item that should be worn for each work type.

### Eighth Example Embodiment

### [Overview]

An assessing device 10 of an eighth example embodiment is a more specific version of the assessing device 10 of the first example embodiment. More specifically, the assessing device 10 of the eighth example embodiment embodies processing of assessing whether a worker to be assessed is wearing a worn item that should be worn. Hereinafter, the configuration of the assessing device 10 will be described in detail.

### [Hardware Configuration]

Since the hardware configuration is the same as that of the assessing device 10 of the second example embodiment, the description thereof will be omitted here.

### [Functional Configuration]

Next, a functional configuration of the assessing device 10 of the present example embodiment will be described in detail. FIG. 1 illustrates an example of the functional block diagram of the assessing device 10. As illustrated, the assessing device 10 includes the reference image acquiring unit 11, the reference image analyzing unit 12, the template information generating unit 13, the target image acquiring unit 14, the target image analyzing unit 15, the assessing unit 16, and the storage unit 17. The assessing device 10 may not include the storage unit 17. In this case, an external device configured to be able to communicate with the assessing device 10 includes the storage unit 17.

The configurations of the reference image acquiring unit 11, the reference image analyzing unit 12, and the template information generating unit 13 are similar to those of any of the first to fourth example embodiments. That is, the assessing device 10 of the present example embodiment generates the worn item template information by any of the means described in the first to fourth example embodiments, and stores the worn item template information in the storage unit 17. Hereinafter, configurations of the target image acquiring unit 14, the target image analyzing unit 15, and the assessing unit 16 will be described.

The target image acquiring unit 14 acquires a target image in which a worker to be assessed appears.

For example, the target image may be an image captured by having a worker stand in front of the camera. Such acquisition of the target image is implemented by means similar to the acquisition of the reference image described in the second example embodiment. This method is optimal for use in assessing workers one by one at any timing such as before start of work.

In addition, the target image may be, for example, an image obtained by imaging a worker who is working at a work site. Such acquisition of the target image is implemented by means similar to the acquisition of the reference image described in the third example embodiment. This method is optimal for use in monitoring a worker who is working.

The target image analyzing unit 15 analyzes the target image and identifies a worn item worn by the worker appearing in the target image. The identification of the worn item worn by the worker appearing in the target image is implemented by means similar to the identification of the worn item worn by the worker appearing in the reference image described in the second example embodiment, for example.

The assessing unit 16 assesses whether the worker to be assessed is wearing the worn item that should be worn based on the worn item identified by the analysis of the target image by the target image analyzing unit 15 and the worn item indicated by the worn item template information. Specifically, the assessing unit 16 assesses whether the worn item indicated by the worn item template information is included in the worn item identified by the analysis of the target image by target image analyzing unit 15. Then, in a case where at least one of the worn items indicated by the worn item template information is not included, the assessing unit 16 assesses that the worker to be assessed is not wearing the worn item that should be worn. Meanwhile, in a case where all of the worn items indicated by the worn item template information is included, the assessing unit 16 assesses that the worker to be assessed is wearing the worn item that should be worn.

The assessing unit 16 can output an assessment result. Hereinafter, output examples in the case of being used for assessing workers one by one at any timing and in the case of being used for monitoring a worker who is working will be described.

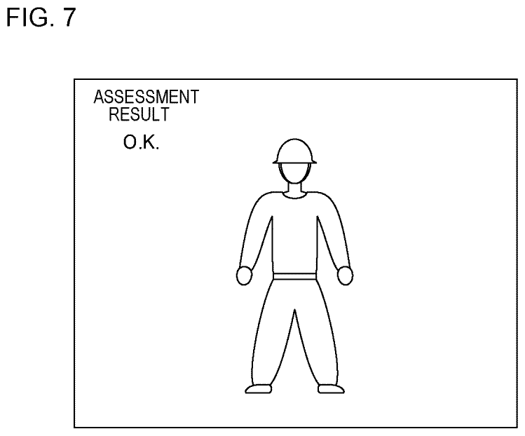

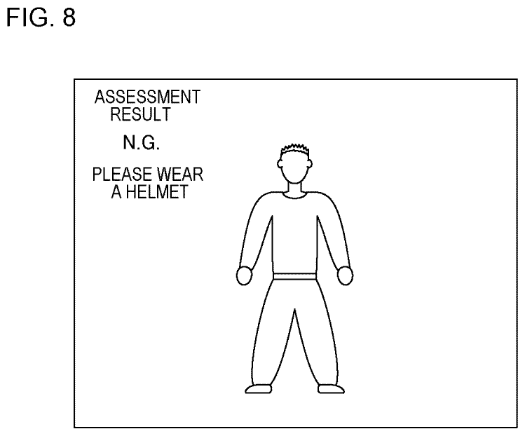

In the case of the purpose of assessing the workers one by one at any timing, as described above, the captured target image is acquired by having the worker stand in front of the camera. As illustrated in FIGS. 7 and 8, the assessing unit 16 can output an image in which information indicating the assessment result is superimposed on the target image.

FIG. 7 is an image that is output in a case where it is assessed that the worker to be assessed is wearing a worn item that should be worn. In the example of FIG. 7, information of “assessment result O.K.” is superimposed and displayed on the target image.

FIG. 8 is an image that is output in a case where it is assessed that the worker to be assessed is not wearing a worn item that should be worn. In the example of FIG. 8, information of “assessment result N.G.” is superimposed and displayed on the target image. Furthermore, in the example of FIG. 8, information indicating a worn item that should be worn but is not worn is superimposed and displayed on the target image. Specifically, in the example of FIG. 8, it is pointed out that the user has forgotten to wear the “helmet”.

For example, a display may be installed near a camera that captures an image of a worker to be assessed. Then, the assessing unit 16 may display an assessment result as illustrated in FIG. 7 or 8 on the display. In this case, imaging of the worker to be assessed and display of the assessment result are performed in real-time processing.

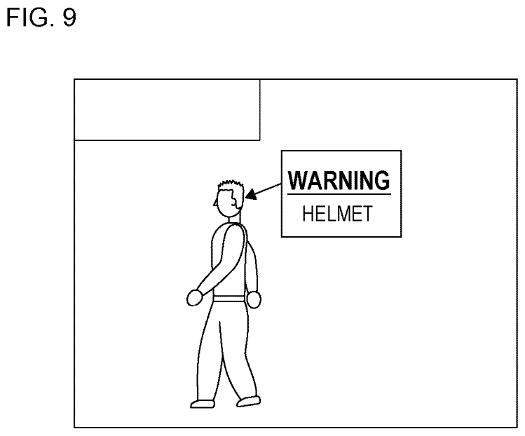

Next, in the case of the purpose of monitoring the worker who is working, the target image obtained by imaging the worker who is working at the work site is acquired as described above. As illustrated in FIG. 9, the assessing unit 16 can output an image in which information indicating an assessment result is superimposed on the target image.

In the example of FIG. 9, information for identifying the worker assessed not to wear the worn item that should be worn is superimposed and displayed on the target image. Furthermore, in the example of FIG. 9, information indicating a worn item that should be worn but is not worn is superimposed and displayed on the target image.

In this example, the assessing unit 16 constantly performs assessment processing on the worker appearing in the target image. Then, in a case where a worker who is not wearing the worn item that should be worn is detected, an image as illustrated in FIG. 9 is output. For example, an image (moving image) obtained by imaging a worker who is working at a work site may be displayed on a display for a supervisor in real time. Then, the assessing unit 16 may superimpose and display the information as illustrated in FIG. 9 on the image displayed on the display for the supervisor.

In addition, the assessing unit 16 may generate a still image as illustrated in FIG. 9 in a case of detecting a worker who is not wearing a worn item that should be worn. The still image is an image obtained by superimposing predetermined information on an image obtained by imaging an image (moving image) obtained by imaging a worker who is working at a work site. Then, the assessing unit 16 may transmit the generated still image to a predetermined destination registered in advance. For example, a terminal, a mail address, or the like of the supervisor is registered as the predetermined destination.

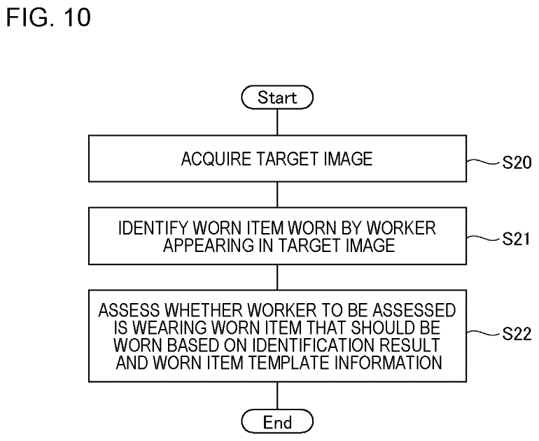

Next, an example of a flow of processing of the assessing device 10 will be described with reference to a flowchart of FIG. 10.

After acquiring the target image in which the worker to be assessed appears (S20), the assessing device 10 analyzes the target image and identifies the worn item worn by the worker appearing in the target image (S21). Next, the assessing device 10 assesses whether the worker to be assessed is wearing the worn item that should be worn based on the worn item identified by the analysis of the target image and the worn item indicated by the worn item template information (S22). Thereafter, the assessing device 10 can output the assessment result.

### [Operations and Effects]

With the assessing device 10 of the eighth example embodiment, operations and effects similar to those of the assessing device 10 of the first and fourth example embodiments are implemented. In addition, with the assessing device 10, it is possible to appropriately assess whether the worker to be assessed is wearing the worn item that should be worn.

### Ninth Example Embodiment

### [Overview]

An assessing device 10 of a ninth example embodiment is a more specific version of the assessing device 10 of the first example embodiment. More specifically, the assessing device 10 of the ninth example embodiment embodies processing of assessing whether a worker to be assessed is wearing a worn item that should be worn. The assessing device 10 of the ninth example embodiment is different from the assessing device 10 of the eighth example embodiment in that the work type of the work performed by the worker to be assessed is identified, and the assessment is performed using the worn item template information associated with the identified work type. Hereinafter, the configuration of the assessing device 10 will be described in detail.

### [Hardware Configuration]

Since the hardware configuration is the same as that of the assessing device 10 of the second example embodiment, the description thereof will be omitted here.

### [Functional Configuration]

Next, a functional configuration of the assessing device 10 of the present example embodiment will be described in detail. FIG. 1 illustrates an example of the functional block diagram of the assessing device 10. As illustrated, the assessing device 10 includes the reference image acquiring unit 11, the reference image analyzing unit 12, the template information generating unit 13, the target image acquiring unit 14, the target image analyzing unit 15, the assessing unit 16, and the storage unit 17. The assessing device 10 may not include the storage unit 17. In this case, an external device configured to be able to communicate with the assessing device 10 includes the storage unit 17.

The configurations of the reference image acquiring unit 11, the reference image analyzing unit 12, and the template information generating unit 13 are similar to those of any of the fifth to seventh example embodiments. That is, the assessing device 10 of the present example embodiment generates the worn item template information by any of the means described in the fifth to seventh example embodiments, and stores the worn item template information in the storage unit 17. Hereinafter, configurations of the target image acquiring unit 14, the target image analyzing unit 15, and the assessing unit 16 will be described.

The target image acquiring unit 14 acquires a target image in which a worker to be assessed appears. The target image acquiring unit 14 can acquire the target image by the means described in the eighth example embodiment.

The target image analyzing unit 15 analyzes the target image and identifies a worn item worn by the worker appearing in the target image. The identification of the worn item worn by the worker appearing in the target image is implemented by means similar to the identification of the worn item worn by the worker appearing in the reference image described in the second example embodiment, for example.

The target image analyzing unit 15 identifies the work type of the work performed by the worker appearing in the target image.

For example, in a case where the target image acquiring unit 14 acquires the captured target image by having the worker stand in front of the camera, the worker is caused to perform an input to designate the work type at the imaging timing. The input is implemented via an input device (touch panel, microphone, operation button, and the like) installed near the camera. Then, information indicating the designated work type is input to the assessing device 10 in association with the target image. Based on the information, the target image analyzing unit 15 identifies the work type of the work performed by the worker appearing in the target image.

In addition, in a case where the target image acquiring unit 14 acquires a target image obtained by imaging a worker who is working at a work site, the target image analyzing unit 15 analyzes the target image and identifies a work type of work performed by the worker appearing in the target image. The processing of identifying the work type through the image analysis is as described in the sixth example embodiment.

The assessing unit 16 assesses whether the worker to be assessed is wearing the worn item that should be worn based on the worn item identified by the target image analyzing unit 15 and the worn item indicated by the worn item template information associated with the work type identified by the target image analyzing unit 15.

Specifically, the assessing unit 16 extracts the worn item template information associated with the work type identified by the target image analyzing unit 15 from the worn item template information (refer to FIG. 6) for each work type registered in advance. Then, the assessing unit 16 assesses whether the worker to be assessed is wearing the worn item that should be worn based on the worn item worn by the worker to be assessed identified by the analysis of the target image by the target image analyzing unit 15 and the worn item indicated by the extracted worn item template information. Details of the assessment processing are as described in the eighth example embodiment.

In addition, the assessing unit 16 can output the assessment result using the means described in the eighth example embodiment.

Next, an example of a flow of processing of the assessing device 10 will be described with reference to a flowchart of FIG. 10.

After acquiring the target image in which the worker to be assessed appears (S20), the assessing device 10 analyzes the target image and identifies the worn item worn by the worker appearing in the target image (S21). In addition, in S21, the assessing device 10 identifies the work type of the work performed by the worker appearing in the target image. Next, the assessing device 10 assesses whether the worker to be assessed is wearing the worn item that should be worn based on the worn item identified by the analysis of the target image and the worn item indicated by the worn item template information associated with the identified work type (S22). Thereafter, the assessing device 10 can output the assessment result.

### [Operations and Effects]

With the assessing device 10 of the ninth example embodiment, operations and effects similar to those of the assessing device 10 of the fifth and seventh example embodiments are implemented. In addition, with the assessing device 10, it is possible to appropriately assess whether the worker to be assessed is wearing the worn item that should be worn.

### Modifications

Hereinafter, modifications applicable to the first to ninth example embodiments will be described.

### [Modification 1]

The target image analyzing unit 15 identifies a plurality of workers appearing in the target image from each other based on the feature quantity of the appearance of the worker.

The feature quantity of the appearance of each of the plurality of workers may be registered in advance. Then, the target image analyzing unit 15 may identify a plurality of workers appearing in the target image from each other based on the feature quantity.

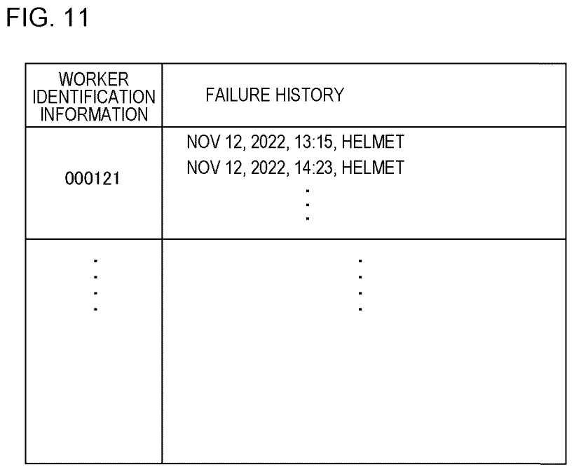

Then, as illustrated in FIG. 11, the assessing unit 16 registers the history of the assessment result of not wearing the worn item that should be worn for each worker.

In the information illustrated in FIG. 11, the worker identification information and the failure history are associated with each other.

In the item of the worker identification information, information for identifying the worker is input.

In the item of the failure history, a history in which it was assessed that the worn item that should be worn was not worn is input. In the illustrated example, the date and time at which it was assessed that the worn item that should be worn is not worn, and the worn item that has not been worn are illustrated.

Based on such a history, it is possible to grasp “which worker is not appropriately wearing the worn item”, “which worn item each worker tends to forget to wear”, and the like.

### [Modification 2]

The assessing device 10 can assess whether the worker to be assessed is wearing the worn item that should be worn based on the image (reference image) of the worker at the start of the work and the image (target image) of the worker who is working.

The reference image acquiring unit 11 acquires a reference image before the start of work on each work day or immediately after the start of work. The reference image analyzing unit 12 analyzes the reference image acquired at such timing. Then, template information generating unit 13 generates the worn item template information based on the analysis result of the reference image acquired at such timing.

The target image acquiring unit 14 acquires a target image captured at the work site during work on each work day. The target image analyzing unit 15 analyzes the target image acquired at such timing. Then, the assessing unit 16 assesses whether the worker to be assessed is wearing a worn item that should be worn based on the analysis result of the target image acquired at such timing.

### [Modification 3]

The target image acquiring unit 14 acquires a target image in which a worker who is working captured at a work site appears. As described above, in the case of the assessment based on the target image obtained by imaging the worker who is working, there is a possibility that the worn item that is actually worn is not detected due to the direction, posture, work content, and the like of the worker, and it is erroneously assessed that the worn item is not worn.

Therefore, the target image analyzing unit 15 tracks the worker detected in the target image (moving image) using a known tracking technique. Then, the target image analyzing unit 15 assesses the worker for a certain period of time.

The assessing unit 16 assesses whether the worker is wearing the worn item that should be worn based on the assessment result within a certain period of time. Specifically, in a case where assessing that a certain worn item has not been worn for a certain period of time, the assessing unit 16 assesses that the worker is not wearing the worn item. Meanwhile, in a case where the assessing unit 16 assesses that a certain worn item is not worn at a certain timing during a certain period of time, but assesses that the worker is wearing the worn item at another timing during the certain period of time, it is assessed that the worker is wearing the worn item. With this configuration, erroneous assessment can be reduced.

### [Modification 4]

The target image acquiring unit 14 acquires a target image in which a worker captured at a work site appears. Then, in Modification 4, a time zone not to be assessed is registered in advance in the assessing device 10. For example, a time zone in which work is not performed, such as a break time or a lunch time, is a time zone not to be assessed.

The assessing unit 16 does not output the warning as illustrated in FIG. 9 even in a case where it is assessed that the worker to be assessed is not wearing the worn item that should be worn based on the analysis result of the target image captured in the time zone not to be assessed. With this configuration, it is possible to reduce the inconvenience of unnecessarily outputting a warning in a time zone not to be assessed in which work is not performed.

### [Modification 5]

The target image acquiring unit 14 acquires a target image in which a worker captured at a work site appears. Then, in Modification 5, an area not to be assessed is registered in advance in the assessing device 10. For example, a place where work is not performed, such as a rest area or a toilet, is a time zone not to be assessed.

The target image analyzing unit 15 further identifies whether the area in which the worker appears in the target image is an “area not to be assessed”. In a case where the camera is a fixed point camera, the area not to be assessed, which is present in the image captured by the camera, may be identified and registered in advance using the coordinates of the image or the like. In this example, the user can designate an area not to be assessed in the image.

### [Modification 6]

The target image acquiring unit 14 acquires a target image in which a worker captured at a work site appears. The target image analyzing unit 15 has means for identifying the worker and other persons. That is, the target image analyzing unit 15 includes means for assessing whether a person appearing in the target image is a worker or not.

Then, in Modification 6, only for the person identified as the worker, the target image analyzing unit 15 identifies the worn item, and the assessing unit 16 assesses whether the worn item that should be worn is worn. That is, with respect to the person assessed not to be the worker, the target image analyzing unit 15 does not identify the worn item and the assessing unit 16 does not assess whether the worn item that should be worn is worn.

There is a possibility that a passerby or the like passing near the work site may appear in the target image depending on a direction or a position of a camera that captures an image of the work site. There is a possibility that the assessment is made on such a passerby and a warning is output. According to the modification, such inconvenience can be suppressed.

Means for identifying a worker and other persons is not particularly limited. For example, the feature quantity of the appearance of each worker may be registered in advance. Then, the target image analyzing unit 15 may perform the identification using the feature quantity.

Although the example embodiments of the present invention have been described above with reference to the drawings, these are examples of the present invention, and various configurations other than the above can be used. The configurations of the above-described example embodiments may be combined with each other, or some configurations may be replaced with other configurations. In addition, various modifications may be made to the configuration of the above-described example embodiments within a range not departing from the scope. In addition, the configurations and processing disclosed in the above-described example embodiments and modifications may be combined with each other.

In the plurality of flowcharts used in the above description, a plurality of steps (processing) are described in order. However, the execution order of the steps executed in each example embodiment is not limited to the described order. In each example embodiment, the order of the illustrated steps can be changed within a range in which there is no problem in content. In addition, the above-described example embodiments can be combined within a range in which the contents are not contradictory.

Some or all of the above example embodiments may be described as the following Supplementary Notes, but are not limited to the following.
1. An assessing device including:
a reference image acquiring means for acquiring a reference image;
a reference image analyzing means for analyzing the reference image and identifying a worn item worn by a worker appearing in the reference image;
a template information generating means for generating worn item template information indicating the worn item that should be worn by the worker, based on an analysis result of the reference image, and storing the worn item template information in a storage means;
a target image acquiring means for acquiring a target image in which a worker to be assessed appears;
a target image analyzing means for analyzing the target image and identifying a worn item worn by the worker appearing in the target image; and
an assessing means for assessing whether the worker to be assessed is wearing the worn item that should be worn based on the worn item identified by analyzing the target image and the worn item indicated by the worn item template information.
2. The assessing device according to 1, in which
the reference image acquiring means acquires an image captured at a work site as the reference image,
the reference image analyzing means identifies a worn item worn by a worker appearing in the image captured at the work site, and
the template information generating means generates the worn item template information based on an analysis result of the image captured at the work site.
3. The assessing device according to 2, in which
the reference image analyzing means detects a predetermined worker from the image captured at the work site based on feature quantities of an appearance of the predetermined worker registered in advance, and identifies a worn item worn by the detected predetermined worker, and
the template information generating means generates the worn item template information indicating the worn item worn by the predetermined worker, as the worn item that should be worn by the worker.
4. The assessing device according to 2, in which
the reference image analyzing means identifies a worn item worn by each of a plurality of workers appearing in the image captured at the work site, and
the template information generating means generates the worn item template information indicating a worn item possessed by a predetermined number or more of workers or a worn item possessed by a predetermined proportion or more of workers among the plurality of workers appearing in the image captured at the work site, as the worn item that should be worn by the worker.
5. The assessing device according to any one of 1 to 4, in which
the reference image analyzing means analyzes the reference image and identifies a work type of a work performed by the worker appearing in the reference image, and
the template information generating means generates the worn item template information for each work type based on the analysis result of the reference image.
6. The assessing device according to 5, in which
the target image analyzing means analyzes the target image and identifies a work type of a work performed by the worker appearing in the target image, and
the assessing means assesses whether the worker to be assessed is wearing the worn item that should be worn based on the worn item identified by analysis of the target image and the worn item indicated by the worn item template information corresponding to the work type identified by the analysis of the target image.
7. The assessing device according to any one of 1 to 6, in which
the target image analyzing means identifies a plurality of workers appearing in the target image from each other based on feature quantities of an appearance of the worker, and
the assessing means registers a history of an assessment result of not wearing the worn item that should be worn for each worker.
8. An assessing method including,
by one or more computers,
acquiring a reference image,
analyzing the reference image and identifying a worn item worn by a worker appearing in the reference image,
generating worn item template information indicating the worn item that should be worn by the worker, based on an analysis result of the reference image, and storing the worn item template information in a storage means,
acquiring a target image in which a worker to be assessed appears,
analyzing the target image and identifying a worn item worn by the worker appearing in the target image, and
assessing whether the worker to be assessed is wearing the worn item that should be worn based on the worn item identified by analyzing the target image and the worn item indicated by the worn item template information.
9. A program that causes a computer to function as
a reference image acquiring means for acquiring a reference image,
a reference image analyzing means for analyzing the reference image and identifying a worn item worn by a worker appearing in the reference image,
a template information generating means for generating worn item template information indicating the worn item that should be worn by the worker, based on an analysis result of the reference image, and storing the worn item template information in a storage means,
a target image acquiring means for acquiring a target image in which a worker to be assessed appears,
a target image analyzing means for analyzing the target image and identifying a worn item worn by the worker appearing in the target image, and
an assessing means for assessing whether the worker to be assessed is wearing the worn item that should be worn based on the worn item identified by analyzing the target image and the worn item indicated by the worn item template information.

This application is based upon and claims the benefit of priority from Japanese patent application No. 2023-010955 filed on Jan. 27, 2023, the disclosure of which is incorporated herein in its entirety by reference.

### REFERENCE SIGNS LIST

10 Assessing device
11 Reference image acquiring unit
12 Reference image analyzing unit
13 Template information generating unit
14 Target image acquiring unit
15 Target image analyzing unit
16 Assessing unit
17 Storage unit
1A Processor
2A Memory
3A Input/output I/F
4A Peripheral circuit
5A Bus

What is claimed is:

1. An assessing device comprising:
at least one memory configured to store one or more instructions; and
at least one processor configured to execute the one or more instructions to:
acquire a reference image;
analyze the reference image;
identify a worn item worn by a worker appearing in the reference image;
generate worn item template information indicating the worn item that should be worn by the worker, based on an analysis result of the reference image, information in a storage means;
store the worn item template information in a storage;
acquire a target image in which a worker to be assessed appears;
analyze the target image;
identify a worn item worn by the worker appearing in the target image; and
assess whether the worker to be assessed is wearing the worn item that should be worn based on the worn item identified by analyzing the target image and the worn item indicated by the worn item template information.

2. The assessing device according to claim 1, wherein the at least one processor is further configured to execute the one or more instructions to
acquire an image captured at a work site as the reference image,
identify a worn item worn by a worker appearing in the image captured at the work site, and
generate the worn item template information based on an analysis result of the image captured at the work site.

3. The assessing device according to claim 2, wherein the at least one processor is further configured to execute the one or more instructions to
detect a predetermined worker from the image captured at the work site based on feature quantities of an appearance of the predetermined worker registered in advance,
identify a worn item worn by the detected predetermined worker, and
generate the worn item template information indicating a worn item worn by the predetermined worker, as the worn item that should be worn by the worker.

4. The assessing device according to claim 2, wherein the at least one processor is further configured to execute the one or more instructions to
identify a worn item worn by each of a plurality of workers appearing in the image captured at the work site, and
generate the worn item template information indicating a worn item possessed by a predetermined number or more of workers or a worn item possessed by a predetermined proportion or more of workers among the plurality of workers appearing in the image captured at the work site, as the worn item that should be worn by the worker.

5. The assessing device according to claim 1, wherein the at least one processor is further configured to execute the one or more instructions to analyze the reference image,
identify a work type of a work performed by the worker appearing in the reference image, and
generate the worn item template information for each work type based on the analysis result of the reference image.

6. The assessing device according to claim 5, wherein the at least one processor is further configured to execute the one or more instructions to
analyze the target image,
identify a work type of a work performed by the worker appearing in the target image, and
assess whether the worker to be assessed is wearing the worn item that should be worn based on the worn item identified by analysis of the target image and the worn item indicated by the worn item template information corresponding to the work type identified by the analysis of the target image.

7. The assessing device according to claim 1, wherein the at least one processor is further configured to execute the one or more instructions to
identify a plurality of workers appearing in the target image from each other based on feature quantities of an appearance of the worker, and
register a history of an assessment result of not wearing the worn item that should be worn for each worker.

8. An assessing method comprising,
by one or more computers,
acquiring a reference image,
analyze the reference image,
identifying a worn item worn by a worker appearing in the reference image,
generating worn item template information indicating the worn item that should be worn by the worker, based on an analysis result of the reference image,
store the worn item template information in a storage,
acquiring a target image in which a worker to be assessed appears,
analyze the target image;
identifying a worn item worn by the worker appearing in the target image, and
assessing whether the worker to be assessed is wearing the worn item that should be worn based on the worn item identified by analyzing the target image and the worn item indicated by the worn item template information.

9. The assessing method according to claim 8, wherein the one or more computers
acquire an image captured at a work site as the reference image,
identify a worn item worn by a worker appearing in the image captured at the work site, and
generate the worn item template information based on an analysis result of the image captured at the work site.

10. The assessing method according to claim 9, wherein the one or more computers
detect a predetermined worker from the image captured at the work site based on feature quantities of an appearance of the predetermined worker registered in advance,
identify a worn item worn by the detected predetermined worker, and
generate the worn item template information indicating the worn item worn by the predetermined worker, as the worn item that should be worn by the worker.

11. The assessing method according to claim 9, wherein the one or more computers
identify a worn item worn by each of a plurality of workers appearing in the image captured at the work site, and
generate the worn item template information indicating a worn item possessed by a predetermined number or more of workers or a worn item possessed by a predetermined proportion or more of workers among the plurality of workers appearing in the image captured at the work site, as the worn item that should be worn by the worker.

12. The assessing method according to claim 8, wherein the one or more computers
analyze the reference image,
identify a work type of a work performed by the worker appearing in the reference image, and
generate the worn item template information for each work type based on the analysis result of the reference image.

13. The assessing method according to claim 12, wherein the one or more computers
analyze the target image,
identify a work type of a work performed by the worker appearing in the target image, and
assess whether the worker to be assessed is wearing the worn item that should be worn based on the worn item identified by analysis of the target image and the worn item indicated by the worn item template information corresponding to the work type identified by the analysis of the target image.

14. The assessing method according to claim 8, wherein the one or more computers to
identify a plurality of workers appearing in the target image from each other based on feature quantities of an appearance of the worker, and
register a history of an assessment result of not wearing the worn item that should be worn for each worker.

15. A non-transitory computer-readable medium storing a program that causes a computer to
acquire a reference image;
analyze the reference image;
identify a worn item worn by a worker appearing in the reference image;
generate worn item template information indicating the worn item that should be worn by the worker, based on an analysis result of the reference image, means;
store the worn item template information in a storage,
acquire a target image in which a worker to be assessed appears;
analyze the target image;
identify a worn item worn by the worker appearing in the target image; and
assess whether the worker to be assessed is wearing the worn item that should be worn based on the worn item identified by analyzing the target image and the worn item indicated by the worn item template information.

16. The non-transitory computer-readable medium according to claim 15, wherein the program causes the computer to
acquires acquire an image captured at a work site as the reference image,
identify a worn item worn by a worker appearing in the image captured at the work site, and
generate the worn item template information based on an analysis result of the image captured at the work site.

17. The non-transitory computer-readable medium according to claim 16, wherein the program causes the computer to
detect a predetermined worker from the image captured at the work site based on feature quantities of an appearance of the predetermined worker registered in advance,
identify a worn item worn by the detected predetermined worker, and
generate the worn item template information indicating a worn item worn by the predetermined worker, as the worn item that should be worn by the worker.

18. The non-transitory computer-readable medium according to claim 16, wherein the program causes the computer to
identify a worn item worn by each of a plurality of workers appearing in the image captured at the work site, and
generate the worn item template information indicating a worn item possessed by a predetermined number or more of workers or a worn item possessed by a predetermined proportion or more of workers among the plurality of workers appearing in the image captured at the work site, as the worn item that should be worn by the worker.

19. The non-transitory computer-readable medium according to claim 15, wherein the program causes the computer to
analyze the reference image, the reference and
identify a work type of a work performed by the worker appearing in the reference image, and
generate the worn item template information for each work type based on the analysis result of the reference image.

20. The non-transitory computer-readable medium according to claim 19, wherein the program causes the computer to
analyze the target image,
identify a work type of a work performed by the worker appearing in the target image, and
assess whether the worker to be assessed is wearing the worn item that should be worn based on the worn item identified by analysis of the target image and the worn item indicated by the worn item template information corresponding to the work type identified by the analysis of the target image.
